(19) United States
(12) Patent Application Publication
(10) Pub. No.: US 2004/0166468 A1
(43) Pub. Date: Aug. 26, 2004

(54) New-tech articulator

(76) Inventor: Mesia Hovsepian, Forest Hills, NY (US)

Correspondence Address: MESIA HOVSEPIAN, 71 - 26 LOUBET ST., FOREST HILLS, NY, 11375, US

(21) Appl. No.: 10/072,484

(22) Filed: Feb. 20, 2003

(51) Int. Cl. A61C 11/00

(52) U.S. Cl. 433/63; 433/57

(57) ABSTRACT

The Articulator is used in the dental field. It combines the upper and lower models of the impression taken by the dentist of the patient's bite. When the dental technician receives the impression, he pours the master models until they dry and the models are combined in the articulator with the use of plaster, to register patient's bite to further design the prosthetic.

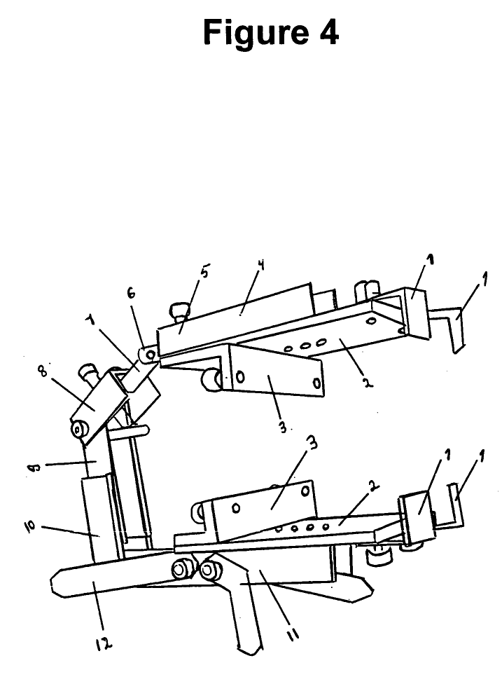

The New-Tech Articulator is designed to be used without the use of plaster. This will eliminate the use of materials such as, plaster, glue, oil, etc. which are time consuming and messy (as shown in FIG. 4).

### BACKGROUND OF INVENTION

The New-Tech Articulator is built by C channel angles, square tubing and bolts, so it can be lighter and stronger than a conventional one. All the parts are connected by bolts and each part can be easy to replace. Some of the holes which are drilled on the parts have a thread, so the bolts can tighten the parts together on the place needed. The New-Tech Articulator is invented to combine 2 dental master models (upper and lower without the use of plaster, glue, oil, drilling of tools) to be able to register the patient's bite taken by the dentist for processing of the dental prosthetics.

The conventional articulator suffers various disadvantage, such as the use of plaster, which is messy and time consuming because of the plaster drying period needed. Also to be able to adjust the bite, the technician needs to break the plaster and pour a new one. Whenever adjustment is needed after first process has to be repeated over from the beginning.

The New-Tech Articulator is designed to be used without the use of plaster. The New-Tech Articulator is built with an adjustable vise that can be used with any size model. The upper horizontal arm is adjustable to any dental movement. The vertical arm has an adjustable up and down movement to pick up the thickness of the models. The bottom arm of the articulator has four standing arms that are easily adjustable to any working position needed. All the movements of the articulator are done by several screws that are inserted to each part of the articulator to hold the position needed.

### DETAILED DESCRIPTION

Below is a detailed explanation of the parts and movements of the dental New-Tech Articulator which is necessary when combining the 2 models (upper and lower) together without the use of plaster.

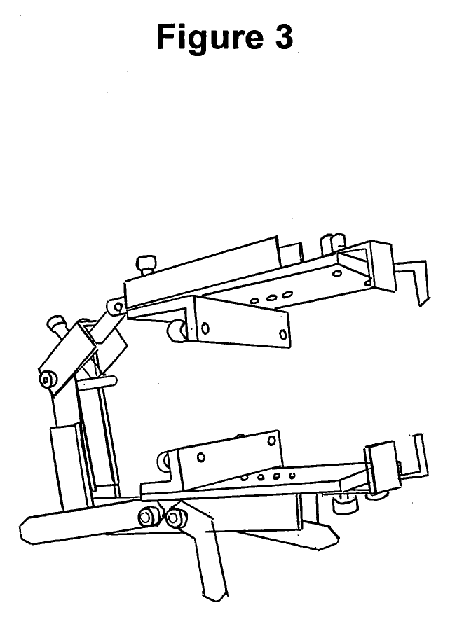

PART # 1 (4 pieces) is an “L” shaped arm. It has a hole with no thread which enables the bolt to go through and connect one of the front holes of PART # 2 which has a thread (shown in FIG. 3). They can rotate 90 degrees counterclockwise and they can be attached to the working model.

PART # 2 (2 pieces) has a rectangular shape, with 8 holes with thread in the middle, connecting to PART # 3. It has also 2 holes on one of the end sides (shown in FIG. 3) connecting to PART # 1.

PART # 3 (2 pieces) is “L” shaped. On the short side it has 2 holes with threads where 2 bolts are inserted (shown in FIG. 3) to tighten the model. On the long side, it has a hole in the middle where a bolt can go through to connect to any one of the 8 holes of PART # 2. These 3 parts when connected become a vise which can be adjusted to hold any shape of a dental model, upper and lower.

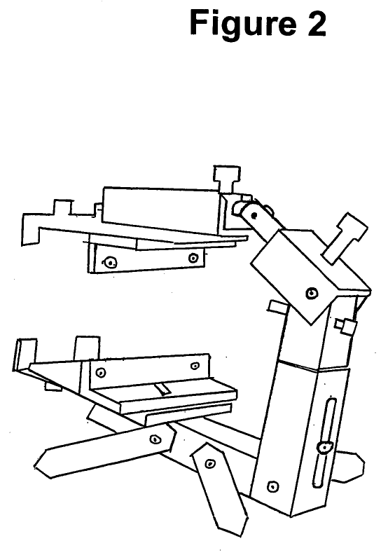

PART # 4 is a C channel, which is connected with PART # 5. Half of this channel has an open side in the middle. A bolt goes through the channel and connects the vise with PART # 4. Therefore enabling the vise to move/slide horizontally, left and right. PART # 4 can rotate 360 degrees clockwise (shown in FIG. 2).

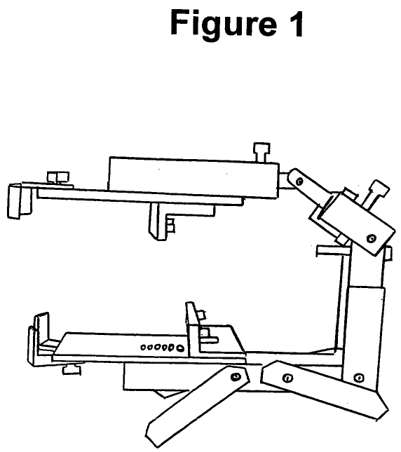

PART # 5 is connected to PART # 4. It has a horizontal hole with a bolt enabling the insertion of PART # 6. It can rotate 360 degrees and horizontally to enable tightening with the bolt to any position needed (shown in FIG. 1, 2, & 3).

PART # 6 is a round bar with one side cut in “L” shape. The “L” shaped part has a hole and knurling in the middle of the flat side, which is connected with a bolt to PART # 7, which also has knurling and thread in the hole. It rotates 180 degrees clockwise and can be tightened to any position. The round side of the bar slides into PART # 5.

PART # 7 is the same shape as PART #6. The round side of the bar has a vertical hole with thread connecting to APRT # 8 (as shown in FIG. 1, 2 & 3).

PART # 8 is a C channel which has a base and 2 arms. The base has a vertical hole connecting to PART # 7 with a bolt. It has another hole which has thread and a long bolt which adjusts the bite opening (shown in FIG. 1, 2, 3, 4, & 5). It also has 2 holes to enable connection to PART # 9, which moved 9-12 clockwise (as show in FIG. 1, 2, 3, 4 & 5). It is also adjustable (left and right) by the 2 bolts.

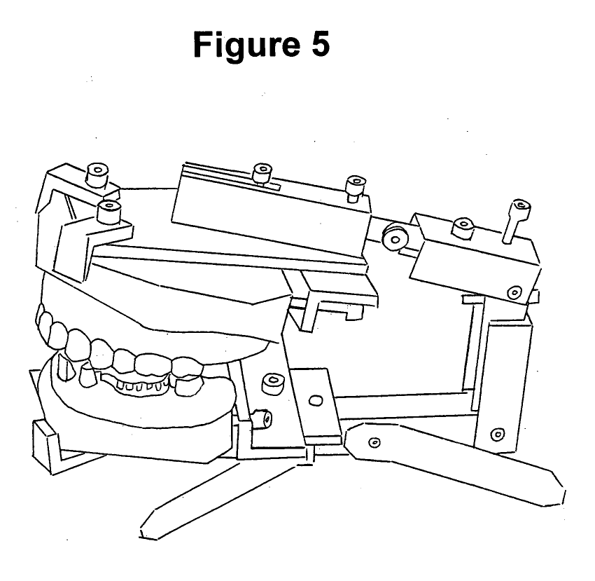

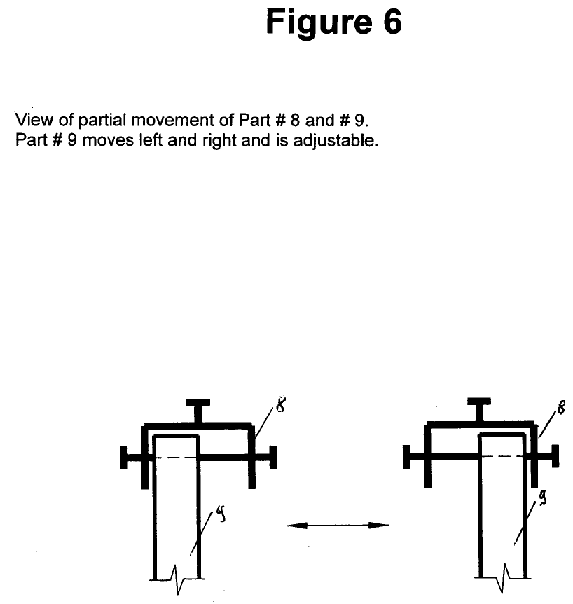

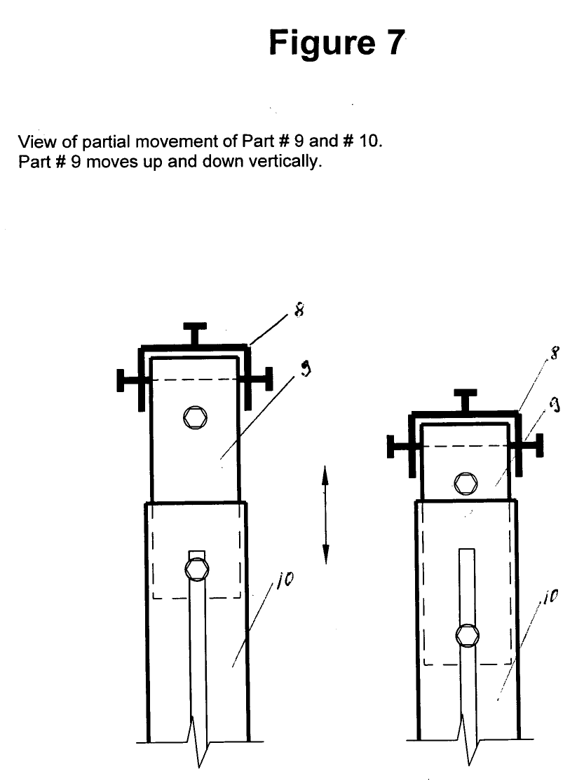

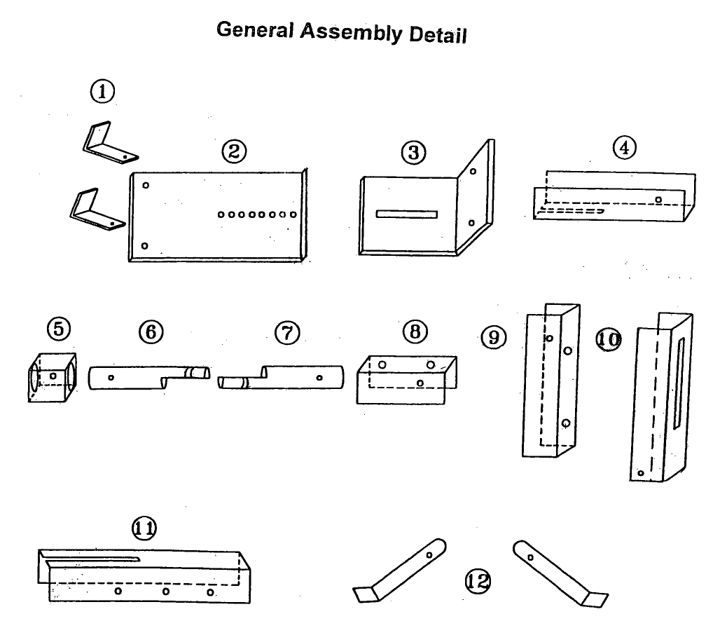

PART # 9 is a smaller C channel with 2 holes on the base and 2 holes on the arms. The armholes are connected with bolts to PART # 8. Both holes on the base have threads. It slides vertically to PART # 10 (shown in FIG. 5 & 6).

PART # 10 is a wider C channel with a slide on the base which the bolt goes through and connects to PART # 9. It can be adjusted and tightened to vertical position (as shown in FIG. 2, 4, & 6).

PART 11 is a C channel with ones side connecting to PART # 10. It is positioned at non-movable 90 degrees. The other side has an open slide in the middle enabling the bolt to go through and connect with the vise. It goes horizontal to the vise and can be tightened to position (shown in FIG. 1, 2, 3, 4, 5, & 6).

PART # 12-4 legs with bolts. These 4 legs can be tightened to the arms of the C channel of PART # 11 and can be set in any position from 0-90 degrees for each leg to accommodate the job.

1. What I claim as my invention is a devise called “New-Tech Articulator”. The articulator is used in the dental field to combine the two master models together of the patient's registered bite without the use of plaster
The conventional articulators are used with plaster to combine the two master models together. There is a waiting period for drying of plaster, which is time and material consuming and is not flexible/adjustable, if patient's bite is not right and has to be redone.
Processing of any dental work with the “New-Tech Articulator”
The “New-Tech Articulator” is designed to be a non-plaster articulator which does not need the use of materials such as plaster, glue, oil, drilling of holes and time consuming.
It is also flexible for adjustments, if needed.
The “New Tech Articulator” is built with an adjustable vise that can be used with any size model. The upper horizontal arm is adjustable to any dental movement. The vertical arm has an adjustable up and down movement to pick up the thickness of the models. The bottom arm of the articulator has four standing arms that are easily adjustable to any working position needed. Al the movements of the articulator are done by several screws that are inserted to each part of the articulator to hold the position needed (as shown in FIG. 1, 2, 3, 4, 5).
